(19) United States
(12) Patent Application Publication
(10) Pub. No.: US 2008/0219736 A1
(43) Pub. Date: Sep. 11, 2008

(54) On-Demand Printing of Coding Patterns

(76) Inventor: Stefan Lynggaard, Lund (SE)

Correspondence Address: BIRCH STEWART KOLASCH & BIRCH, PO BOX 747, FALLS CHURCH, VA, 22040-0747, US

(21) Appl. No.: 10/586,532

(22) PCT Filed: Feb. 11, 2005
(86) PCT No.: PCT/SE05/00177

§ 371 Date: Jul. 19, 2006

Related U.S. Application Data
(60) Provisional application No. 60/544,238, filed on Feb. 13, 2004.

(30) Foreign Application Priority Data
Feb. 13, 2004 (SE) 0400322-4

(51) Int. Cl. B41J 11/44

(52) U.S. Cl. 400/76

(57) ABSTRACT

A technique is provided to enable reproduction of a high-precision code symbol, which comprises a mark with a given location with respect to a reference point, using a comparatively low-resolution printing device which is arranged to apply dots of marking material in a resolution grid on a substrate. The resolution gris is defined by the dot resolution of the printing device and is composed as a two-dimensional array of dot-receiving cells. To enable the reproduction, the printing device is provided with data that represents the code symbol. Further, the printing device is controlled, based on the data, to reproduce the code symbol by arranging the reference point of the code symbol inside one of the dot-receiving cells and by applying at least one dot of marking material on the substrate.

### CROSS-REFERENCE TO RELATED APPLICATIONS

The present application claims the benefit of Swedish patent application No. 0400322-4 and U.S. provisional patent application No. 60/544,238, which were both filed on Feb. 13, 2004 and which are hereby incorporated by reference.

### FIELD OF THE INVENTION

The present invention generally relates to printing of coding patterns on digital printers.

### BACKGROUND ART

It is known to use a coding pattern to embed some type of information in a passive base such as a sheet of paper, a writing board or equivalent. A suitably programmed scanner, fax machine, camera or digital pen can then read, recreate and use the information embedded locally in the base. For example, graphical human-readable information on a base can be supplemented with embedded machine-readable information which extends the functionality of the base. Such embedded information can comprise file data for full or partial recreation of the graphical information, commands, supplementary text or images, hyperlinks, absolute positions, etc.

Coding patterns are generally constructed around some form of machine-readable code symbols which are regularly spaced on the base. Examples of such coding patterns are given in U.S. Pat. No. 5,221,833; U.S. Pat. No. 5,477,012; U.S. Pat. No. 6,570,104; U.S. Pat. No. 6,663,008; US 2002/0021284; and U.S. Pat. No. 6,330,976.

In many cases, bases with a coding pattern can be generated on a large scale and with high precision in the graphics industry, e.g. using offset printing. There are, however, occasions when it is desirable to create bases with a coding pattern on a relatively small scale. This could be carried out using a personal computer, to which a digital printer of, for example, the ink-jet or laser type, has been connected. However, such on-demand generation of coded bases on digital printers generally results in an inferior quality of the coding pattern unless the resolution of the digital printer is at least of the same magnitude as the spatial frequencies for the allowable tolerances in the information-carrying details of the coding pattern. At present, such a high-resolution printer may not be available to the average user, or to professional users such as print shops, printing agencies and print centers.

### SUMMARY OF THE INVENTION

An object of the present invention thus is to provide a printing technique that overcomes the above problems.

These and other objects that will be evident from the following description are now achieved wholly or partly by a method, an arrangement, and an apparatus according to independent claims 1, 12 and 13, respectively. Further embodiments are defined in the dependent claims.

### BRIEF DESCRIPTION OF THE DRAWINGS

The invention will now be described by way of example with reference to the accompanying drawings, which schematically illustrate currently preferred embodiments.

FIG. 1 is an enlarged view of a prior art coding pattern.

FIG. 2A is a schematic view of an arrangement implementing a reproduction method according to the invention.

FIG. 2B is a schematic view of a base with an information layer and a coding layer.

FIG. 3 is a flow chart of a reproduction method according to the invention.

FIG. 4A is an enlarged view of a resolution grid and code symbol areas of a nominal coding pattern.

FIG. 4B is a view of FIG. 4A after resealing, arranging of reference points, and application of dots in the resolution grid.

FIG. 4C is a view that corresponds to FIG. 4B, but for a printer with twice the resolution.

FIG. 5 is a view to illustrate a step of adjusting an information layer to a rescaled coding layer.

FIG. 6 is a schematic block diagram of an electronic circuitry part in the printer shown in FIG. 2A.

### DETAILED DESCRIPTION OF THE INVENTION

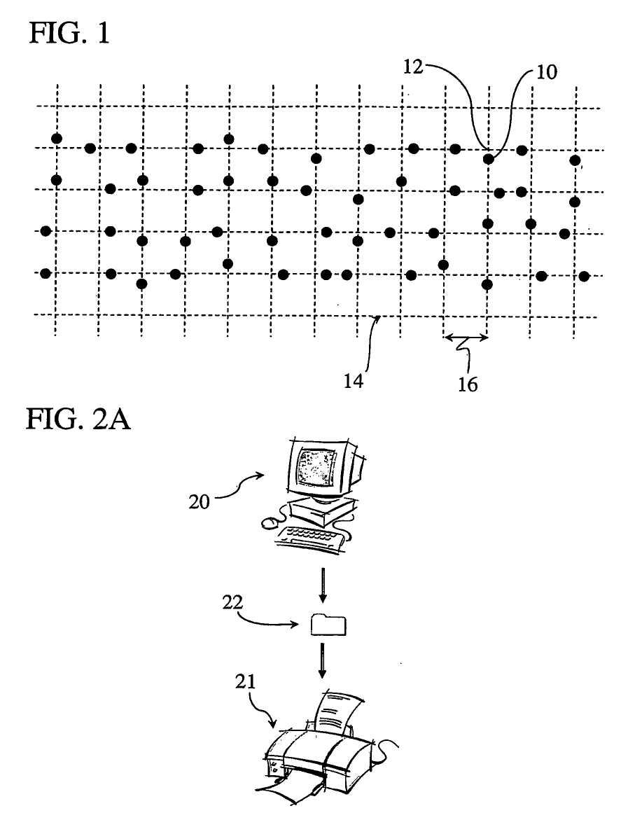

FIG. 1 illustrates a part of an absolute position-coding pattern, which will be used to exemplify the invention. The position-coding pattern is detailed in Applicant's U.S. Pat. No. 6,663,008, which is incorporated herein by this reference. Principally, the coding pattern of FIG. 1 is made up of simple graphical symbols, which can assume four different values and thus are capable of coding two bits of information. Each symbol consists of a mark 10 and a spatial reference point or nominal position 12, the center of the mark 10 being displaced or offset a distance in one of four different directions from the reference point 12. The value of each symbol is given by the direction of displacement. The symbols are arranged with the nominal positions 12 forming a regular raster or grid 14 with a given grid spacing, as indicated by reference numeral 16. The reference point and/or the grid may be virtual, i.e. invisible to any decoding device, and thus not explicitly included in the coding pattern.

In one exemplary embodiment, the coding pattern has a nominal grid spacing of 300 μm, a nominal offset distance of 50 μm, and a mark radius in the range of about 30-60 pm. In such an embodiment, the allowable deviations from the nominal values may be around ±5-10 μm which corresponds to spatial frequencies of about 2,500-5,000 dpi.

Each absolute position is coded in two dimensions by the collective values of a group of symbols within a coding window, e.g. containing 6×6 adjacent symbols. Further, the coding is “floating”, in the sense that an adjacent position is coded by a coding window displaced by one grid spacing. In other words, each symbol contributes in the coding of several positions.

The coding pattern of FIG. 1 may also be used to code both positions and other data, or only other data than positions, as disclosed in Applicant's US Patent Publication No. 2001/0038349.

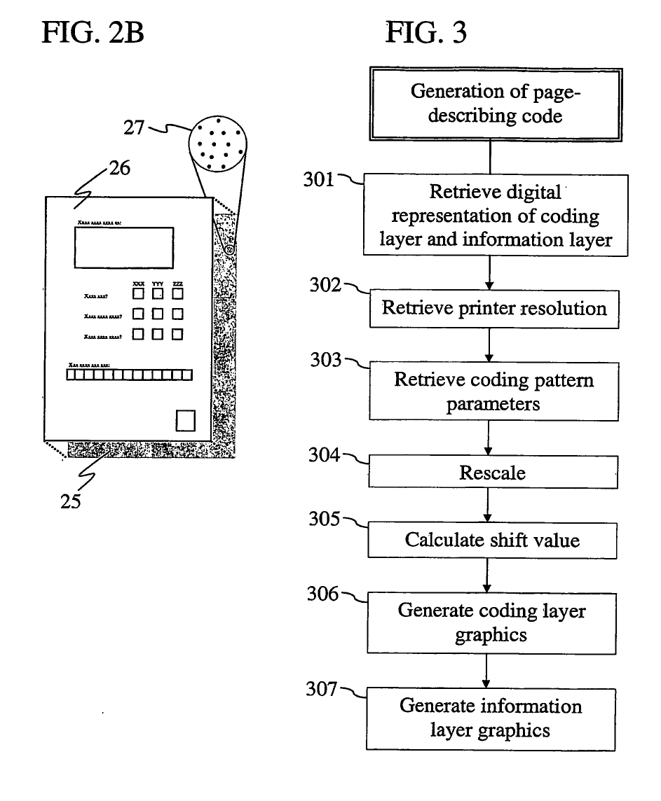

An arrangement for printing such a high-precision coding pattern is shown in FIG. 2A. The arrangement includes a computer 20 and a printer 21. The printer 21 may be communicatively connected to the computer 20, so that a page-describing file 22 can be transferred from the computer 20 to the printer 21.

The computer 20 has access to a digital representation of the coding pattern which is to be applied as a machine-readable coding layer on a base, for example a sheet of paper. The computer system may also have access to a digital representation of graphical data which is to be printed as a human-readable information layer on the same base. The graphical data may include text, drawings, rulings, images, etc, typically to guide or inform the user of the coded base. FIG. 2B illustrates a combination of such a coding layer 25 and information layer 26, the coding and information layers being separated for purposes of illustration only. FIG. 2B also includes an enlarged view of the coding pattern 27. As will be further described below, the computer 20 is capable of generating a page-describing code of the coding layer 25 and, if present, the information layer 26. The following examples assume that the page-describing code is text-based and written in the widely adopted PostScript (trademark) programming language, although other types of formats and programming languages are certainly conceivable, for example PCL (Printer Control Language).

The printer 21 receives the file 22, reads the page-describing code therein and converts it to adequate printing instructions. Most commercially available printers have such capability. The operating principle of the printer can be based on any technology that applies a marking material to a substrate so as to produce mono-chrome or polychrome printouts, including but not limited to ink jet, laser, dye-sublimation, solid ink, thermal wax, thermal autochrome, and dot matrix technology.

The printer has a rated resolution or full dot resolution, typically given in dots per inch (dpi), which is the highest resolution that can be achieved in printouts of pure black and white images. Often, the printer supports selection of a lower resolution, a sub-resolution, for example to increase the printing speed.

The resolution of the printer may be represented as a two-dimensional grid of non-overlapping dot cells. At the rated resolution, each such dot cell may be populated by a single dot. At the sub-resolution, each dot cell may be populated by multiple dots. Conceptually, the dot cells have rectangular shape, with the sides of the dot cell defining a respective dot cell dimension. In practice, however, the dots are not rectangular. Both the size and shape of the dots are dependent upon printing technology. For example, dots in adjacent dot cells may, e.g. due to dot gain, overlap to some extent. Some printers may even be capable of controlling the size of the individual dots that populate the dot cells.

The PostScript programming language provides operators, which control generation and/or placement of objects, such as text, geometric figures and sampled images, on a so-called current page. When the current page is completed, the printer may be commanded to rasterize the current page and print the resulting image. The positions on the current page are defined by xy coordinate pairs in a user coordinate system imposed on the current page. By default, the user coordinate system originates in the bottom left corner of the current page. Thus, the origin coincides with the lower left corner of the lower left dot cell of the resolution grid.

After placing an object at an insertion position on the current page, the insertion position may be automatically advanced to the next dot cell that follows after the object on the same vertical line (y coordinate) or on the same horizontal line (x coordinate), depending on implementation.

It has been found that using PostScript programming language to describe and command printout of the above coding pattern may result in relatively large individual variations in the code symbols, specifically in the shape of the mark and/or in the location of the mark with respect to the reference point.

This problem has been essentially overcome by designing the PostScript code to shift the reference point of each code symbol from a corner of a dot cell to the interior of a dot cell, as will be described in more detail with reference to the following exemplifying embodiments.

FIG. 3 is a flow chart of a method for generating a page-describing code that embodies the principles of the present invention. This method may be implemented by the processor of the computer 20.

In step 301, a digital representation of the coding layer is retrieved, suitably from a memory associated with the computer 20. The memory may thus be located either internally or externally of the computer 20. The digital representation of the coding layer may be supplied to the computer 20 in pre-generated form, or be generated by the computer 20 on demand. For example, the digital representation may include the above-mentioned symbol values, or derivatives thereof, with the mutual spatial ordering of the symbols being retained. Similarly, step 301 may include retrieval of a digital representation of the information layer to be printed.

In step 302, a current resolution value of the printer is retrieved. This resolution value may indicate the full resolution of the printer or any sub-resolution chosen by the user of the computer.

In step 303, parameter values of the coding pattern are retrieved. For the pattern of FIG. 1, these parameters include mark offset, mark size, and grid spacing.

In step 304, a scaling factor is calculated to adapt the grid spacing to the resolution grid. More specifically, the scaling factor brings the grid spacing to equal the collective dot cell dimension of an integer number of dot cells, with minimum deviation from the nominal grid spacing. The scaling factor may differ between the vertical (y) and horizontal (x) directions. This resealing has been found to, inter alia, suppress moiré effects and thereby promote uniformity in the printed coding pattern.

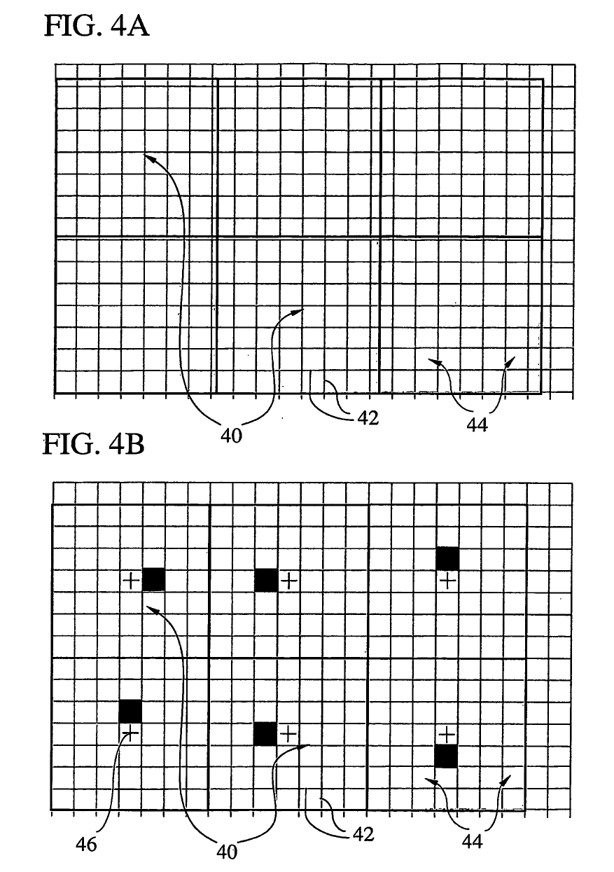

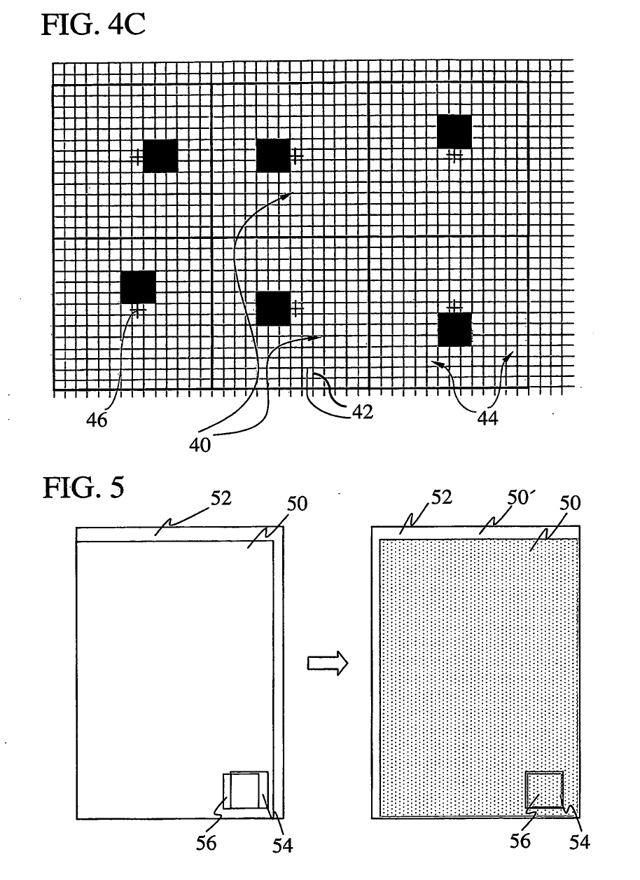

In FIG. 4A, code symbol areas 40 of the above coding pattern are overlaid on the resolution grid 42 of a 600 dpi printer. The code symbol areas 40 are designed to hold one code symbol each and are tiled in a non-overlapping fashion to form the coding pattern. Thus, the side length of the areas 40 is equal to the nominal grid spacing. The code symbol areas 40 and the resolution grid 42 are only visualized on the drawings for the purpose of illustrating that there is a mismatch between the code symbol areas (dimension 300 μm×300 μm)and the dot cells (dimension 42.3 μm×42.3 μm). This mismatch may be corrected by multiplying the nominal grid spacing (300 μm) with a scaling factor α of 0.98778, yielding an actual grid spacing of 296 μm.

In step 305, a shift value for the reference points is calculated based on the resolution value that was retrieved in step 302. For example, the shift value may represent a shift of half a dot cell dimension upwards and half a dot cell dimension to the right.

FIG. 4B illustrates the use of the shift value in commanding the printer to generate the code symbols. For purposes of illustration, the reference point 46 is visualized on the drawings, although it need not be visible on the printed base. As shown in FIG. 4B, instead of being placed by default at the down left corner of a relevant dot cell, the reference point is shifted (by 21.15 μm) to the actual center point of the dot cell. The printer is then instructed by the page-describing code to generate, at an offset distance of 49.39 μm (α×50 μm) from the thus-shifted reference point, a circular mark with a radius of 29.63 μm (α×30 μm). The printer forms the code symbol by populating one dot cell as close as possible to the set offset, resulting in an actual offset of one dot cell (42.3 μm). As mentioned above, the actual appearance and size of the printed mark will depend on printing technology.

FIG. 4C corresponds to FIG. 4B but illustrates the resolution grid of a 1200 dpi printer. For each code symbol, the printer may populate nine dot cells for each mark. The resulting mark offset will be two dot cells (42.3 μm).

Moving the reference point away from the edges of the dot cell has proven to result in a distinct improvement of the stability in the shapes of the resulting marks and the relative location of the mark centers to the reference points. Presently, it is believed that optimum results are obtained by bringing the reference point to essentially coincide with the center of a dot cell.

Returning now to FIG. 3, a page-describing code is generated in step 306 to command the printer to generate the appropriate code symbols at the appropriate locations, according to the principles illustrated in FIGS. 4B-4C. Thus, the page-describing code is generated based on the digital representation of the coding pattern, the retrieved parameter values of the coding pattern, the scaling factor, and the shift value. The shift value may be incorporated in the definition for each code symbol, by shifting the location of the reference point within the code symbol area, or as an overall shift/translation of the user coordinate system.

The page-describing code may be implemented according to prior art techniques, known to the person skilled in the art. For example, the page-describing code for the coding layer may be generated as a set of function/program calls, one call for each code symbol. Alternatively, the page-describing for the coding layer may be generated as a set of characters, each character representing a unique group of code symbols with a given spatial arrangement, as disclosed in Applicant's International patent publication WO 2004/104818, which is incorporated herein by reference. Possibly, each such character may be associated with a font definition which is sent to or pre-stored in the printer. Still further, the page-describing code for the coding layer may be generated based on an image definition that reflects one or more basic number sequences of the coding pattern, as disclosed in Applicant's International patent publication WO 2005/001754, which is incorporated herein by reference.

In step 307, a page-describing code is generated for the information layer. Again, this step may be implemented according to prior art techniques, known to the person skilled in the art.

The thus-generated page-describing code may include instructions to rescale the information layer, suitably by the above scaling factor (derived in step 305). However, the information layer may originate from a file format that does not allow for such resealing, for example PDF (Portable Document Format) which is designed to preserve the graphical appearance of a document.

Evidently, there will be a mismatch between the coding and information layers, if one is rescaled but not the other. This mismatch may cause problems if a reading device, which is operated on the printed base, is to associate predefined functions with sets of positions coded by the coding layer and if these sets are indicated graphically in the information layer.

FIG. 5 illustrates such a mismatch between a rescaled coding layer 50 and an original information layer 52. In this example, the information layer defines a functional box 54, which is intended to match with a position-coding area 56 dedicated to initiate a sending function in the reading device. Clearly, the sending function may be initiated even if the reading device is positioned outside the functional box, and vice versa.

One way to deal with this mismatch is to translate the entire coding layer so as to realign the functional box 54 and the related area 56, as illustrated in the right-hand part of FIG. 5. In this process, a feature of the functional box 54 is essentially aligned with a corresponding feature of the area 56. Such a feature may be a corner point or a center point. If the information layer contains multiple functional boxes, the translation may be calculated so as to minimize the mismatch in all such boxes, possibly also accounting for the size of each box. In any case, such a translation should preserve the relation between the relative location (given by the shift value) between the reference points of the code symbols and the dot cells of the resolution grid.

As an additional measure, the coding layer may be extended to fully match the information layer by adding code symbols in the otherwise non-coded periphery 50 (cross-hatched portion in FIG. 5). If the coding pattern is designed to code positions in one or two dimensions, the added code symbols may code positions that are contiguous with the originally included positions.

Following step 307, the page-describing code for the coding layer and the page-describing code for the information layer may be combined in a final page-describing file.

It should be noted that steps 301-305 may be effected in any order, although the calculation of the shift value requires knowledge about the printer's resolution. Similarly, the order of steps 306 and 307 may be reversed. Further, the steps may be modified. For example, the resealing step may operate on the grid spacing, whereas the mark size and/or the mark offset remain unaffected. In some embodiments, the resealing step may be omitted. Further, the shift value may be retrieved, for example from a definition file, instead of being calculated based on the printer's resolution. In fact, all steps 303-305 may be substituted for a step of deriving header data for the page-describing code, for example from a definition file, based on the printer's resolution. Clearly, step 307 may be omitted, in the absence of any information layer.

The above generation of the page-describing code(s) may be carried out in the computer 20 (FIG. 2A) under control of a computer program, which may be embodied on a record medium, stored in a computer memory, embodied in a read-only memory or carried on an electrical carrier signal.

In another embodiment, the printer operation need not be controlled by programming instructions in a page-describing file. Instead, the printer has a dedicated pattern generation module, which is implemented by software and/or hardware to generate the coding pattern. On receipt of a request for print-out of a coding pattern, the module may retrieve a digital representation of the coding pattern, as well as the printer resolution, the parameter values of the coding pattern, and the shift value. The module may also effect resealing of the coding pattern. Finally, the module generates the printable image based on the digital representation. The request for print-out may include the digital representation, for example in the form of the above-mentioned symbol values. Alternatively, as described in Applicant's U.S. Publication No. 2002/0159089, the request may include only information indicating the boundaries of the absolute positions to be coded on the base, whereupon the module is capable of deriving the relevant digital representation.

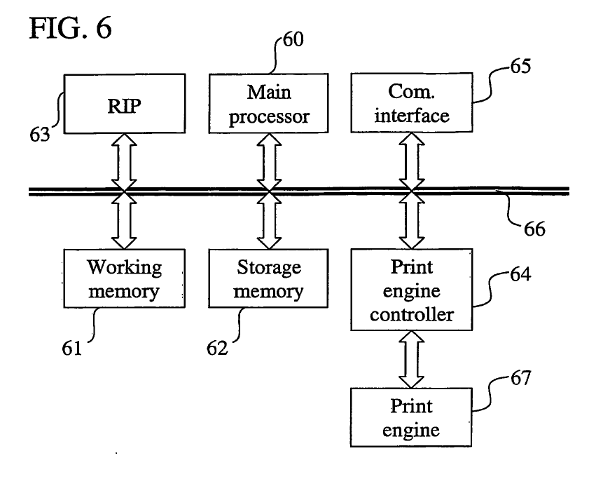

For the sake of completeness, FIG. 6 illustrates some main components of a conventional digital printer that may be used to print a coding pattern according to the invention. Such a digital printer may include a main processor 60 (e.g. CPU, microprocessor), a working memory 61 (e.g. RAM), a storage memory 62 (e.g. ROM, PROM, EEPROM, flash), a raster image processor (RIP) 63, a print engine controller 64, and a communications interface 65 (e.g. USB, Firewire, IrDA, Bluetooth, Ethernet, parallel port, modem) which are interconnected over a bus structure 66. The storage memory 62 holds the software for the main processor 60 and the RIP 63, as well as configuration data including any resident fonts. When the main processor 60 receives the page-describing file via the communications interface 65, it operates the RIP 63 to convert the page-describing code into a rasterized image, which is stored in the working memory 61. Optionally, the page-describing file may be processed to generate the coding layer and the information layer in two separate images. The print engine controller 64 is then operated to retrieve the rasterized image(s) from the working memory 61 and control a print engine 67 to generate a hardcopy of the rasterized image(s). Further, the printer may be provided with the above-mentioned pattern generation unit, implemented as a hardware unit connected to the bus structure 66, as a software unit stored in the storage memory 62, or as a combination thereof.

There are many variations that may be made consistent with the present invention. The foregoing description is presented for purposes of illustration and description. It is not exhaustive and does not limit the invention to the precise form disclosed. Modifications and variations are possible in light of the above teachings or may be acquired from practicing the invention.

For example, the principles of the present invention may be implemented to improve on-demand printing of a high-precision coding pattern using a comparatively low-resolution printing device. Further examples of such coding patterns are found in U.S. Pat. No. 5,221,833; U.S. Pat. No. 5,245,165; U.S. Pat. No. 5,449,896; U.S. Pat. No. 5,862,255; U.S. Pat. No. 6,000,613; U.S. Pat. No. 6,330,976; U.S. Pat. No. 6,622,923; DE 10118304; US 2002/0021284; US 2002/0033820; US 2003/0066896; US 2003/0085270 and US 2004/0086181.

Further, the dots may be applied to the resolution grid using single or multiple passes, and using single or multiple dot layers.

Still further, the inventive solution is equally applicable to printers having different resolutions in the horizontal and vertical directions (x and y directions).

The term “digital printer” as used herein is intended to designate all kinds of digital reproduction equipment, including but not limited to plotters, desktop printers, office printers, production presses, printing presses, and copiers.

The bases that are generated by means of the invention may be used in an information management system, in which a handheld device tracks its motion on a printed base, by reading off positions coded thereon, and communicates resulting position-related data to an application program in a receiving station. In the system, each printed base has at least one dedicated application program which associates specific processing instructions with one or more data input areas on the printed base. The printing of a base results in the generation of allocation data which associates the graphics in the information layer with the positions in the coding layer. This allocation data is used by system components that direct the position-related data from the handheld device to the correct application program. The allocation data may also be used by the application program to correctly correlate the received position-related data with the data input area(s). Such an information management system is disclosed in Applicant's International patent publication WO 2004/038651, which is incorporated herein by this reference.

If the present invention is incorporated in such an information management system, printout correction data may be made available in the system, for example as part of the allocation data, to allow the application program to correctly correlate the position-related data with the data input area(s). Such printout correction data may represent the scaling factor and/or any translation of the coding layer. However, translation data may be omitted if the translation is carried out based on convention, i.e. according to a default rule which is known within the system.

1. A method of reproducing a code symbol on a substrate, said code symbol comprising a mark with a given location with respect to a reference point, said method comprising:
providing a printing device with data representing said code symbol, said printing device being configured to apply dots of marking material in a resolution grid on the substrate, said resolution grid being defined by the dot resolution of the printing device and comprising a two-dimensional array of dot-receiving cells; and
controlling, based on said data, the printing device to reproduce said code symbol by arranging the reference point of said code symbol inside one of said dot-receiving cells and by applying at least one dot of marking material on the substrate.

2. The method of claim 1, wherein the reference point is arranged essentially at the geometric center the dot-receiving cell.

3. The method of claim 1, further comprising applying said at least one dot at said given location with respect to the reference point.

4. The method of claim 1, wherein said mark is displaced from said reference point parallel to a grid line of said resolution grid.

5. The method of claim 1, wherein said given location is defined as a displacement of the geometric center of said mark with respect to the reference point.

6. The method of claim 1, wherein the dot resolution is the rated full dot resolution of the printing device.

7. The method of claim 1, wherein the printing device is a digital printer.

8. The method of claim 7, further comprising generating said data as a page-describing code and controlling the digital printer to convert the page-describing code into a printable image.

9. The method of claim 1, wherein the printing device is a print engine of a digital printer.

10. The method of claim 1, further comprising controlling the printing device to reproduce an additional code symbol on the substrate, the spacing between the reference points of said at least one additional code symbol and said code symbol being controlled to essentially match an integer number of said dot-receiving cells.

11. The method of claim 1, which results in a coding layer being reproduced on said substrate, said coding layer comprising a plurality of code symbols, the reference point of each code symbol being arranged inside one of said dot-receiving cells, said method further comprising:
providing further data representing a human-readable information layer to the printing device; and
controlling, based on said data and said further data, the printing device to reproduce the coding and information layers with a spatial match between a given feature in the information layer and a given feature in the coding layer.

12. An arrangement for reproducing a code symbol on a substrate, said code symbol comprising a mark with a given location with respect to a reference point, said arrangement comprising:
means for providing a printing device with data representing said code symbol, said printing device being configured to apply dots of marking material in a resolution grid on the substrate, said resolution grid being defined by the dot resolution of the printing device and comprising a two-dimensional array of dot-receiving cells; and
means for controlling, based on said data, the printing device to reproduce said code symbol by arranging the reference point of said code symbol inside one of said dot-receiving cells and by applying at least one dot of marking material on the substrate.

13. An apparatus for reproducing a set of code symbols on a substrate, each code symbol comprising a mark with a given location with respect to a reference point, said apparatus comprising:
a first input for obtaining at digital representation of said set of code symbols;
a second input for obtaining data relating to the dot resolution of a printing device, said dot resolution defining a two-dimensional array of dot-receiving cells with respect to the substrate; and
an instruction generator which generates printing instructions to control, based on the digital representation and the resolution data, the printing device to reproduce said set of code symbols by arranging the reference point of each code symbol inside one of said dot-receiving cells and by applying at least one dot of marking material on the substrate.

14. The apparatus of claim 13, wherein the printing device is a digital printer.

15. The apparatus of claim 14, wherein said instruction generator generates said instructions as a page-describing code which is converted into a printable image by the printer.

16. The apparatus of claim 14, which is included in said printer.
